(19) United States
(12) Patent Application Publication
(10) Pub. No.: US 2017/0198804 A1
(43) Pub. Date: Jul. 13, 2017

(54) Vehicle drive axle half shaft

(71) Applicant: Dongfeng Commercial Vehicle Company Limited, Wuhan City (CN)

(72) Inventors: CHUNLI LIU, Wuhan City (CN); YONGHUA CHEN, Wuhan City (CN); MING JIANG, Wuhan City (CN); JIN LIU, Wuhan City (CN); KAI HU, Wuhan City (CN); WEI LIU, Wuhan City (CN); HONGYAN XING, Wuhan City (CN); HONGXING ZHANG, Wuhan City (CN)

(21) Appl. No.: 15/151,270

(22) Filed: May 10, 2016

(30) Foreign Application Priority Data
Jan. 7, 2016 (CN) 201610016597.8

(51) Int. Cl. F16H 57/04; F16C 3/02

(52) U.S. Cl. CPC F16H 57/0427; F16C 3/02; F16H 57/0493

(57) ABSTRACT

A vehicle drive axle half shaft, which belongs to a half shaft used for a vehicle drive axle with an oil-lubricated structure, includes a shaft body (41) and bonding portions located at both ends of the shaft body (41), or includes a shaft body (41), a bonding portion located at one end of the shaft body (41) and a flange (43) located at the other end of the shaft body (41); a helical structure (8) is provided on an outer surface of the shaft body (41), and when the shaft body (41) rotates for driving a wheel hub (7) and a vehicle to move forward, a direction in which the helical structure (8) conveys lubricating liquid is toward one side of a main speed reducer (1). It has a simple structure and a novel design, and is conveniently manufactured, and may keep the amount of oil in various cavities stable, so as to ensure adequate lubrication of various components. Particularly, it has good effects on oil gas exhaustion and cooling of the wheel end mechanism (2), and effectively extends the service life of the drive axle system, thus being suitable for all oil-lubricated vehicle drive axle.

### TECHNICAL FIELD

The present invention relates to a driver shaft for transaxle, and particularly, to a vehicle drive axle half shaft with a wheel end oil-lubricated structure.

### BACKGROUND ART

A drive axle is disposed at the tail end of a powertrain, and torque emitted by an engine is finally transmitted to drive wheels through the drive axle, thereby enabling rotation of wheels. For a single-stage drive axle, oil lubrication is mainly used for wheel end bearings; and for a wheel reduction drive axle, both hub bearings and wheel reducer need to consider the oil lubrication.

The existing drive axle, such as the wheel reduction drive axle of Dongfeng Commercial Vehicle Co., Ltd., as shown in FIG. 4, mainly comprises a main speed reducer 1, a wheel end mechanism 2, a drive axle housing 3, a half shaft 4, a driven bevel gear 5, a shaft tube 6 and a wheel hub 7; the main speed reducer 1 comprises a driving bevel gear and a driven bevel gear 5, wherein the driven bevel gear 5 is a helical bevel gear, and the lower half of the driven bevel gear 5 is basically immersed in the lubricating oil; the drive axle housing 3 and the shaft tube 6 are linked together by four positioning pins and interference fit; the main speed reducer 1 is mounted in a mounting hole in the center of the drive axle housing 3 by bolts; the half shaft 4 is disposed in the drive axle housing 3 and the shaft tube 6; the main speed reducer 1 is connected with the wheel end mechanism 2 through the half shaft 4; the wheel end mechanism 2 is mounted on the wheel hub 7, while the wheel end mechanism 2 and the wheel hub 7 are mounted on the shaft tube 6. When the vehicle is running, the driving bevel gear in the main speed reducer 1 operates at a high speed, so as to drive the driven bevel gear 5 to operate at a high speed; the driven bevel gear 5 rotates like a “propeller”, producing unidirectional pumping action, and allowing gear lubricating oil at the main speed reducer 1 to flow along the driven bevel gear 5 into a cavity of the drive axle housing 3 and along the drive axle housing 3 into the wheel end mechanism 2.

Roads in China and most countries in the Northern Hemisphere are lower on the right and higher on the left, that is, under the joint action of road longitudinal slope and the unidirectional pumping capability of the driven bevel gear 5, lubricating oil in the main speed reducer 1 in the center of the drive axle will flow to one side, usually to the cavity of the right wheel end mechanism 2 and cannot flow back. Due to the fact that the wheel end mechanism 2 is not provided with a breather plug mechanism, the inside of the wheel end mechanism 2 including the wheel reducer becomes a closed cavity where friction pairs, such as wheel end bearings and gears, constantly heat the lubricating oil in the cavity, and meanwhile a large amount of high-temperature and high-pressure oil gas is produced; as the gathered high-pressure oil gas gets more and more, the wheel end mechanism 2 just likes a constantly heated “pressure cooker” at the moment, the gear oil in the high-pressure airtight cavity is more and more boiling, accordingly the oil temperature in the cavity of the wheel end mechanism 2 on one side of the vehicle rises sharply until the viscosity of the lubricating oil is destroyed; as a result, parts in the wheel end mechanism 2 are abnormally abraded due to poor lubrication, or even gear scuffing or hub oil seal invalidation caused oil leakage and other faults are produced.

The utility model with Chinese Patent Publication No.: CN203082000U, Date of the announcement: Jul. 24, 2013, entitled “COMMERCIAL VEHICLE HALF SHAFT”, discloses a vehicle half shaft which is a hollow shaft, the surface of a central hole of the hollow shaft is provided with a helical groove disposed on an inner wall of the central hole, thus reducing the weight of the half shaft and improving the resistance of the half shaft to fatigue deformation. However, the central hole of the half shaft is not communicated with friction pairs, such as bearings and gears, of an axle end mechanism, thus not changing the lubricating status of the axle end mechanism, failing to stop lubricating oil in the axle housing from flowing into the wheel end mechanism, and failing to prevent the temperature of lubricating oil in the wheel end mechanism from rising, not to say achieving the purposes of reducing the temperature of the wheel end mechanism and extending its service life.

### SUMMARY OF THE INVENTION

The present invention aims to solve the problem of the existing wheel end mechanisms that poor heat dissipation and easy occurrence of high-temperature oil gas lead to frequent failures and thus short service life of the wheel end mechanism, and provides A vehicle drive axle half shaft which can effectively reduce the internal temperature of the wheel end mechanism, thus extend the service life of the wheel end mechanism and its surrounding components, and which has the advantages of simple structure, low cost, mature technology, convenient production and remarkable heat dissipation and cooling effects on the wheel end mechanism.

To achieve the above object, the technical solution of the present invention is: A vehicle drive axle half shaft, comprising a shaft body and bonding portions located at both ends of the shaft body, or comprising a shaft body, a bonding portion located at one end of the shaft body, and a flange located at the other end of the shaft body, characterized in that: a helical structure is provided on an outer surface of the shaft body, and when the shaft body rotates for driving a wheel hub and a vehicle to move forward, a direction in which the helical structure conveys lubricating liquid is toward one side of a main speed reducer.

The helical structure is a single-headed or multi-headed helical rib, helical groove or helical tube.

The helical rib is formed from a metal wire or rubber fixed on the outer surface of the shaft body.

The helical rib or helical groove is integrally formed on the shaft body by swaging or machining.

The helical tube is constituted by a metal tube fixed on the outer surface of the shaft body.

The shape of the cross section of the helical rib is rectangular, conical, trapezoidal, semicircular or circular; the shape of the cross section of the helical groove is a rectangular groove, a conical groove, a trapezoidal groove or a semicircular groove; and the shape of the cross section of an inner hole in the helical tube is circular or quadrangular.

The maximum height of the helical rib or the maximum depth of the helical groove is 1 to 4 mm, and the maximum radial height of the helical tube is 2 to 4 mm

Compared with the prior art, the beneficial effects of the present invention are:

1. A helical structure is provided on the outer circumferential surface of the shaft body of the vehicle drive axle half shaft. During advancement of the vehicle, the helical structure can push a part of lubricating oil on one side of the wheel end mechanism towards one side of the main speed reducer during its rotation with the half shaft. As a result, firstly the amount of oil of the wheel end mechanism can be maintained stable and redundant oil of the wheel end mechanism can be actively excluded during travel of the vehicle, preventing the blocking of the wheel end gas channel and the single-side accumulation of the gear oil. Secondly, the lubricating oil of the wheel end can perform heat exchange with the lubricating oil of the main speed reducer to assist heat dissipation of the wheel end mechanism. Thirdly, the oil amount of the main speed reducer is ensured, so that all components of the main speed reducer are fully lubricated, meanwhile the operating temperature of the main speed reducer is reduced, and the service life of the main speed reducer is prolonged.

2. Through observation and research, the inventor has found that: the conditions of generating high temperature oil gas within the wheel end mechanism are: high-speed rotation of the wheel end mechanism and excessive accumulation of the lubricating oil block the exhaust passage of the wheel end mechanism, thereby forming a closed space. The half shaft is the drive element for the movement of the wheel-side mechanism, and there is a positive correlation between them. The pumping action of the helical structure within the sleeve also has a positive correlation to the rotation speed of the half shaft, that is, only the rotation speed of the half shaft increases, the rotation speed of the gears or bearings within the wheel end mechanism can be increased, while the pumping capability of the helical structure can be improved due to the increase of the rotation speed of the half shaft, that is to say, under a constant load, when the vehicle speed increases, the power of the wheel end mechanism will be increased, the amount of heat generated from the wheel end gears and bearings will be accordingly increased, meanwhile the gas exhaust and heat dissipation effect of the wheel end imposed by the helical line on the half shaft is also enhanced. Therefore, with regard to the wheel end mechanism rotating at a high speed, the helical line structure of the present invention uses the rotation characteristics of the half shaft itself, simultaneously increasing the gas exhaust and heat dissipation capability as well as the capability of the wheel end components, exactly and correspondingly resolving the problem of deterioration of gas exhaust and abnormal heating of the wheel end due to the accumulation of the lubricating oil within the wheel end mechanism when the wheel end mechanism rotates at a high speed.

The present invention has the advantages of simple structure, novel design, low cost, mature technology as well as simple and convenient in manufacturing, can be suitable for all vehicle drive axle half shafts employing oil as lubricant, has a good temperature cooling effect on the wheel end mechanism, and effectively prolongs the service life of the wheel end mechanism and its surrounding components.

### BRIEF DESCRIPTION OF THE DRAWINGS

FIG. 1 is a schematic diagram of a structure of the present invention;

FIG. 2 is a schematic diagram of an another structure of the present invention;

FIG. 3 is a schematic diagram of the structure of a drive axle equipped with the half shaft 4 of the present invention; and

FIG. 4 is a schematic diagram of the structure of the existing drive axle.

In the drawings, a main speed reducer 1, a wheel end mechanism 2, a drive axle housing 3, a half shaft 4, a driven bevel gear 5, a shaft tube 6, a wheel hub 7, a helical structure 8, a shaft body 41, a spline 42 and a flange 43.

### DETAILED DESCRIPTION OF THE INVENTION

The present invention will now be further described in detail with reference to the brief description of drawings and specific embodiments.

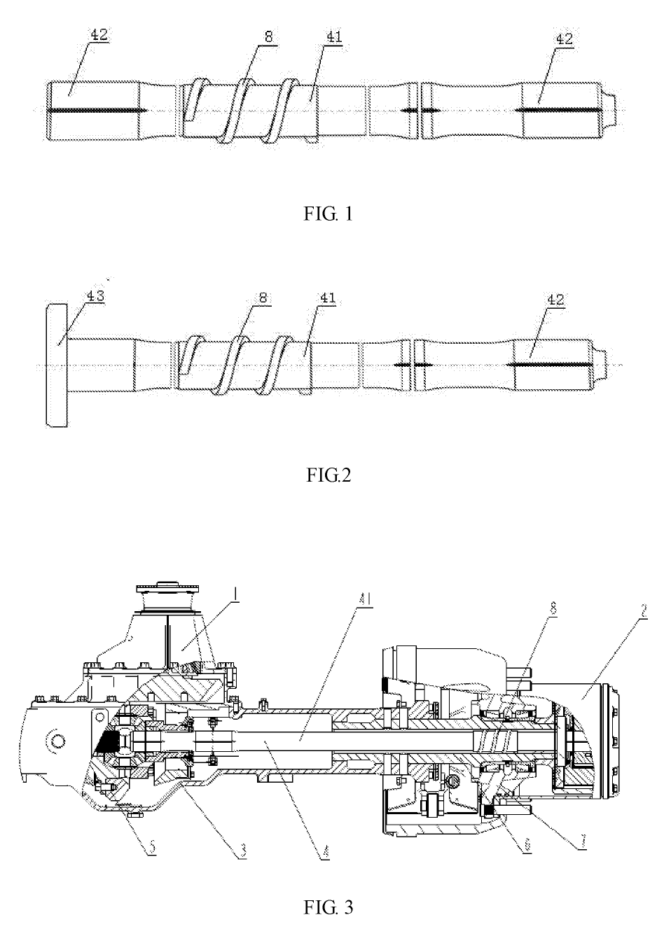

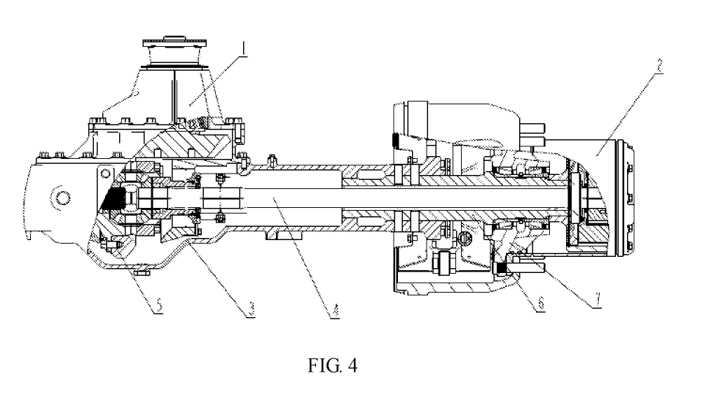

Referring to FIGS. 1, 2 and 3, A vehicle drive axle half shaft includes a shaft body 41 and bonding portions located at both ends of the shaft body 41, or includes a shaft body 41, a bonding portion located at one end of the shaft body 41 and a flange 43 located at the other end of the shaft body 41, a helical structure 8 is provided on an outer circumferential surface of the shaft body 41, and when the shaft body 41 rotates for driving a wheel hub 7 and a vehicle to move forward, a direction in which the helical structure 8 conveys lubricating liquid is toward one side of the main speed reducer 1.

The helical structure 8 is a single-headed or multi-headed helical rib, helical groove or helical tube.

The rotating direction of the helical structure 8 can be determined according to a left/right-hand rule of the existing helix material conveying direction. The right hand is used for left-rotating direction, the left hand is used for the right-rotating direction, with the thumb pointing the material conveying direction, and then the direction of four gripping fingers is the rotation direction of the axis according to the left/right-hand rule. In FIG. 3, the rotating direction of the helical structure 8 is determined by the rotation direction of the shaft body 41 when driving the drive axle and the vehicle to move forward and the direction of fluid in the helical structure 8 flowing to one side of the main speed reducer according to the left/right-hand rule of the helix material conveying direction. That is, the rotating direction of the helical structure 8 is determined by its own lubricating oil conveying direction and the rotation direction of the shaft body 41; in particular, firstly determine the rotation direction of the shaft body 41 when driving the wheels to rotate and the vehicle to move forward, further take the direction from the wheel end pointing to the main speed reducer 1 as the conveying direction of the helical structure 8 or the movement direction of the lubricating oil, then take the bending direction of four fingers as the rotation direction of the shaft body 41, and take the thumb straight direction as or the conveying direction or the movement direction of the lubricating oil; if the right hand conforms with these two directions, the rotating direction of the helical structure 8 on the shaft body 41 shall be left-rotating, and if the left hand conforms with these two directions, the rotating direction of the helical structure 8 on the shaft body 41 shall be right-rotating. This is the conclusion that the rotating direction of the helical structure on the shaft body 41 is determined according to the left/right-hand rule of the existing helix material conveying direction. That is, the rotating direction of the helical structure 8 is determined by the rotation direction of the shaft body 41 and the material conveying direction of the helical structure 8.

The bonding portions may be spline 42 or connections having single bonds, depending upon the structure of elements to be connected, such as gears or the wheel hub 7.

Referring to FIGS. 1 to 3, according to the present invention, the cross-sectional shape of the half shaft 4 is generally circular, so the outer surface shall be an outer circumferential surface; when the cross-sectional shape of the half shaft 4 is polygonal, such as hexagonal or octagonal, the outer surface shall be an outer surface of a prism, such as hexagonal prism or octagonal prism; when the cross-sectional shape of the half shaft 4 is a notched single bond slot shape, or a spline shape with multiple bond slots, the outer surface of the half shaft 4 refers to the surface of a partial cylinder formed by the outer perimeter of the cross section of the half shaft, not including the surface of the portion forming the opening portion of the bond slot and lower than the outer perimeter of the half shaft 4; accordingly, the outer surface of the half shaft 4 refers to the surface of a partial or whole cylinder formed by the outer perimeter of the cross section of the half shaft.

The helical structure 8 is disposed on the shaft body 41, and the maximum outer diameter of the helical structure 8 is smaller than the minimum inner diameter of the shaft tube 6. The helical structure 8 on the shaft body 41 is generally a continuous structure, such as a continuous helical rib, helical groove or helical tube. However, the helical rib disposed on the shaft body 41 may also be an intermittently spaced discontinuous structure. The entire length of the helical structure 8 may be an axial mating length for the shaft body 41 and the shaft tube 6, or may be shorter.

The helical rib is formed from a metal wire or rubber fixed on the outer surface of the shaft body 41. In fact, the helical rib or helical groove may be fixed on the surface of the half shaft 4 through bolts, retainers, gluing, welding, vulcanized rubber surface and the like. It may also be integrally formed in the production process of half shaft 4 blank by direct forging or machining

The helical tube is constituted by a metal tube fixed on the outer surface of the shaft body 41.

The cross-sectional shape of the helical rib is rectangular, conical, trapezoidal, semicircular or circular, the cross-sectional shape of the helical groove is rectangular, conical, trapezoidal or semicircular groove, and the cross-sectional shape of the inner hole in the helical tube is circular or quadrangular.

The maximum height of the helical rib or the maximum depth of the helical groove is 1-4 mm, and the maximum radial height of the helical tube is 2-4 mm The height of the helical rib or the depth of the helical groove is 1-4 mm, and the maximum radial height of the helical tube is 2-4 mm,

### Embodiment 1

Referring to FIGS. 1 and 3, the vehicle drive axle half shaft of the present invention is also referred to as half shaft of wheel reduction axle, comprising a shaft body 41 and splines 42 located at both ends of the shaft body. The outer circumferential surface of the shaft body 41 is provided with a helical structure 8. The rotation direction of the helical structure 8 is determined by the rotation direction of the shaft body 41 when driving the drive axle and the vehicle to move forward and the direction of fluid in the helical structure 8 flowing to one side of the main speed reducer according to the left/right-hand rule. That is, the rotation direction of the helical structure 8 is determined by the rotation direction presented by the half shaft 4 when the wheels on the drive axle rotate forward and the direction of the helical structure conveying the lubricating oil. As in FIG. 3, the half shaft 4 located on the right of the main speed reducer 1 is the right half shaft of the drive axle, in this situation the forward direction of the vehicle is upwards, the rotation direction of the half shaft 4 in FIG. 3 is the same as the forward rotational direction of the wheels, that is, as seen from the drawing, the upper half of the shaft body 41 rotates in a direction away form the reader, and the lower half rotates in a direction towards the reader, the direction of the helical structure 8 conveying the lubricating oil is from the wheel end mechanism 2 towards a side of the main speed reducer 1, now, if putting the thumb of the right hand in the direction of conveying the lubricating oil, the other four fingers are just directed towards the reader below the shaft body 41, thus matching the right hand rule, and the rotation direction of the helical structure 8 is left-rotating, that is, the helical structure 8 on the right half shaft is left-rotating, and vice versa the helical structure 8 on the left half shaft is right-rotating.

Overall, with regard to the half shaft 4 on the right of the drive axle in FIG. 3, the configuration of the helical structure 8 on the shaft body 41 forms a helical pump suction trend in the direction of conveying the liquid on a side of the wheel end mechanism 2 to the main speed reducer 1. As long as the wheel hub 7 or the wheel on the drive axle rotates forward, potential energy of allowing the fluid to move towards an end of the main speed reducer 1 along the rotation direction of the helical structure 8 will be generated within the space where the half shaft 4 and the shaft tube 6 engage with each other, thus driving some lubricating oil within the drive axle housing 3 to move towards a side of the main speed reducer 1. The working principles of the left and right half shafts 4 on the drive axle are identical, but due to the directions of helical structures 8 on each half shaft 4 conveying the lubricating oil is opposite, forming that the rotation direction of the helical structure 8 on the right half shaft is left-rotating, while the rotation direction of the helical structure 8 on the left half shaft is right-rotating.

Referring to FIG. 3, when a vehicle runs on a domestic classified highway at a high speed for a long time, the working state of low right and high left is formed on two sides of a drive axle, but the oil amount at the right-side wheel end is greater than that at the left end due to the fact that the oil surface is horizontal, namely the right side of the drive axle is low while the left side is high, meanwhile the lubricating oil in the main speed reducer 1 at the center of the drive axle flows towards the cavity mostly provided with a right-side wheel end mechanism 2 on one side under the effect of the suction capacity of a driven bevel gear 5 one-way pump and cannot flow back. Due to the fact that the wheel end mechanism 2 is not provided with a breather plug mechanism, the inside of the wheel end mechanism 2 including a wheel-side speed reducer is changed into a closed cavity, a wheel end bearing, a gear and other friction pairs in the cavity constantly heat the lubricating oil in the cavity, meanwhile a large amount of high-temperature and high-pressure oil gas is produced, the gathered high-pressure oil gas gets more and more, the wheel end mechanism 2 just likes a constantly heated “pressure cooker” at the moment, the gear oil in the high-pressure airtight cavity is more and more boiling, accordingly the temperature of the oil in the cavity of the wheel end mechanism 2 on one side of the vehicle rises sharply until the viscosity of the lubricating oil is destroyed, parts in the wheel end mechanism 2 are abnormally abraded due to poor lubrication, or even gear scuffing or hub oil seal invalidation caused oil leakage and other faults are produced. After the structure of the embodiment is adopted and in the rotating process of the half shaft 4 for driving the hub 3 to move forward, due to the fact that a helical structure 8 with the conveying direction facing one side of the main speed reducer is arranged on the outer circumferential surface of the shaft body 41, a part of lubricating oil inside a drive axle housing 3 would flow towards one side of the main speed reducer 1 in the rotation direction of the helical structure 8, under the suction effect of the reverse spiral suction pump, firstly, the oil amount stability of the wheel end mechanism 2 can be kept, the redundant oil amount of the wheel end mechanism 2 is initiatively eliminated in the running process of the vehicle, and blockage of a wheel end air channel and single-side gear oil gathering are prevented. Secondly, the lubricating oil of the wheel end mechanism 2 can perform heat exchange with the lubricating oil of the main speed reducer 1 to assist heat dissipation of the wheel end mechanism 2. Thirdly, the oil amount of the main speed reducer 1 is ensured, so that all parts in the main speed reducer 1 are fully lubricated, meanwhile the working temperature of the main speed reducer 1 is reduced, and the service life of the main speed reducer 1 is prolonged.

The helical structure 8 is a single-headed helical rib spiraling on the outer circumferential surface of the shaft body 41, the helical rib is disposed at a position on the shaft body 41 mating with the shaft tube 6, and the cross-sectional shape of the helical rib is rectangular, and may also be conical, trapezoidal, semicircular or circular. The helical rib is a helical rubber layer formed on the outer circumferential surface of the shaft body 41 by a vulcanized formation process; the height of the prepared helical rubber rib, i.e., the height of the helical rib, is about 1 to 3 mm, 3 mm in this embodiment, and is usually controlled to be less than 4 mm; if the height of the rubber helical rib is too large, it is not allowed by the spatial structure inside of the shaft tube 6, moreover, it causes increased reverse torque for the shaft body 41, and significantly increases power losses in power transmission by the shaft body 41. It shall be ensured that the maximum outer diameter of the helical rib is less than the minimum inner diameter of the shaft tube 6, and the gap between the former two is 0.5 to 3 mm, and 2 mm in this embodiment, in order to prevent the friction between the helical structure 8 and the shaft tube 6. The smaller the mating gap between the helical structure 8, for example, the helical rib and shaft tube 6 is, the greater the helical pumping effect of the helical structure 8 is, and the greater the gap is, the smaller the helical pumping effect of the helical structure 8 is; thus, the pumping capacity, location and extent of oil drawing of the helical structure 8 shall be designed based on the specific needs. The helical rib made of rubber has lighter mass and better flexibility; there may be a smaller gap between the obtained helical structure 8 and the shaft tube 6; even a tiny friction between the rubber material and the shaft tube 6 will neither affect rotation of the half shaft 4, nor produce friction noise. The helical rib or helical groove may also be integrally formed on the shaft body by swaging or machining

When the vehicle is in the high speed running state, the half shaft 4 is the transmission element which drives the wheel end mechanism 2 to move, so the half shaft 4 and the wheel end mechanism 2 are positively correlated in the rotation speed, and since the pumping effect of the helical structure 8 is also positively correlated with the rotation speed of the half shaft 4, under a constant load, when the vehicle speed increases, the power of the wheel end mechanism 2 will increase, the heat generated from the wheel end gears and bearings will be accordingly increased, the same with the rotation speed of the half shaft 4 at the same time, and as a result, the gas exhaust and cooling effects from the helical structure 8 on the half shaft 4 on the wheel end mechanism 2 will also be enhanced. Therefore, for the fast rotating wheel end mechanism 2, by use of the rotation characteristics of the half shaft 4 in the structure, the gas exhaust and cooling capacity of the helical structure 8 on half shaft 4 correspondingly reduce/eliminate heat generation phenomenon of the wheel end mechanism 2, which better solves the problem of abnormally heated wheel ends due to poor exhaust caused by excessive accumulation of lubricating oil in the wheel end mechanism.

The applicant carries out comparative tests on the wheel reduction axle of a Dongfeng commercial vehicle according to the structure of this embodiment 1;

The drive axle in the test group employs a full floating half shaft. A wheel speed reducer is provided at the wheel end, and splines 42 are disposed at both ends of the shaft body 41 of the half shaft 4. The height of the helical rib (i.e. the rubber rib) on the outer circumferential surface of the shaft body 41 is 3 mm, the cross-sectional shape of the helical rib is rectangular, and the minimum radial gas between the helical rib and the shaft tube 6 is 2 mm

The drive axle in the control group employs a full floating half shaft 4, which is a general standard half shaft provided with splines 42 at both ends, and a wheel speed reducer at the wheel end. Other structures of the drive axle in the test group and the control group are the same.

The test is carried out in a way of whole-vehicle on the road, the vehicle continuously operates for four hours according to the standard of full speed 100 km/h, the maximum temperatures of three portions, i.e., the left wheel end, the middle main speed reducer (central) and right wheel end of the drive axle in the whole process are recorded, respectively. Results are shown in the following Table 1:

TABLE 1

| | | Right wheel | Left wheel |
|---|---|---|---|
| | Central maximum | maximum | maximum |
| Half shaft state | temperature (° C.) | temperature (° C.) | temperature (° C.) |
| Control group | 86 | 183 | 88 |
| Test group | 87 | 81 | 81 |

### Embodiment 2

Referring to FIG. 2 and FIG. 3, the vehicle drive axle half shaft is a semi-floating half shaft 4 on the right side of the oil-lubricated drive axle, the half shaft 4 includes a shaft body 41, a bonding portion located at one end of the shaft body, and a flange 43 located at the other end of the shaft body, the bonding portion is a spline, and a helical structure 8 is provided on the outer circumferential surface of the shaft body 41, the rotation direction of the helical structure 8 is left-rotating, and the helical structure 8 is a double-headed helical rib spiraling on the outer circumferential surface of the shaft body 41, the helical rib is arranged in the middle of the half shaft 4 on the side close to the wheel end, the helical rib is formed from a copper wire fixed on the outer circumferential surface of the shaft body 41 by glueing, and the diameter of the metal wire, that is the height of the helical rib, is 2 mm, which is typically controlled to less than 4 mm, and the cross-sectional shape of the helical rib is circular, and it may as well be rectangular, conical, trapezoidal or semicircular. The other structures of this embodiment are substantially the same as those of the first embodiment.

### Embodiment 3

Referring to FIG. 1 and FIG. 3, the vehicle drive axle half shaft is a full-floating half shaft 4 on the right side of the wheel reduction axle, which includes a shaft body 41 and splines 42 located at both ends of the shaft body 41, and a helical structure 8 is provided on the outer circumferential surface of the shaft body 41, the rotation direction of the helical structure 8 is left-rotating, and the helical structure 8 is a single-headed helical groove spiraling on the outer circumferential surface of the shaft body 41, the helical groove is arranged at a length position of the shaft body 41 on the half shaft 4 corresponding to the shaft tube 6, the cross-sectional shape of the helical groove is a semicircular groove, and it may as well be a rectangular, conical, or trapezoidal groove.

The depth of the helical groove is about 1-4 mm, which is typically controlled to less than 4 mm, and it should be assured that the maximum outer diameter of the helical groove is less than the minimum inner diameter of the shaft tube 6. The other structures of this embodiment are substantially the same as those of the first embodiment.

### Embodiment 4

In conjunction with FIG. 1 and FIG. 3, the vehicle drive axle half shaft is a full-floating half shaft 4 on the left side of the wheel reduction axle, which includes a shaft body 41 and splines 42 located at both ends of the shaft body 41, and a helical structure 8 is provided on the outer circumferential surface of the shaft body 41, the rotation direction of the helical structure 8 is right-rotating, and the helical structure 8 is a single-headed helical tube spiraling on the outer circumferential surface of the shaft body 41, the helical tube is formed from a metal tube fixed on the outer circumferential surface of the shaft body 41, the outer diameter of the metal tube is 4 mm, and the inner diameter thereof is 3 mm; and the cross-sectional shape of the housing and the inner hole of the helical tube is quadrilateral. The other structures of this embodiment are substantially the same as those of the first embodiment.

1. A vehicle drive axle half shaft, comprising a shaft body (41) and bonding portions located at both ends of the shaft body (41), or comprising a shaft body (41), a bonding portion located at one end of the shaft body (41), and a flange (43) located at the other end of the shaft body (41), characterized in that: a helical structure (8) is provided on an outer surface of the shaft body (41), and when the shaft body (41) rotates for driving a wheel hub (7) and a vehicle to move forward, a direction in which the helical structure (8) conveys lubricating liquid is toward one side of a main speed reducer (1).

2. The vehicle drive axle half shaft according to claim 1, characterized in that: the helical structure (8) is a single-headed or multi-headed helical rib, helical groove or helical tube.

3. The vehicle drive axle half shaft according to claim 2, characterized in that: the helical rib is formed from a metal wire or rubber fixed on the outer surface of the shaft body (41).

4. The vehicle drive axle half shaft according to claim 2, characterized in that: the helical rib or helical groove is integrally formed on the shaft body by swaging or machining.

5. The vehicle drive axle half shaft according to claim 2, characterized in that: the helical tube is constituted by a metal tube fixed on the outer surface of the shaft body (41).

6. The vehicle drive axle half shaft according to claim 2, characterized in that: the shape of the cross section of the helical rib is rectangular, conical, trapezoidal, semicircular or circular; the shape of the cross section of the helical groove is a rectangular groove, a conical groove, a trapezoidal groove or a semicircular groove; and the shape of the cross section of an inner hole in the helical tube is circular or quadrangular.

7. The vehicle drive axle half shaft according to claim 2, characterized in that: the maximum height of the helical rib or the maximum depth of the helical groove is 1 to 4 mm, and the maximum radial height of the helical tube is 2 to 4 mm.

8. The vehicle drive axle half shaft according to claim 6, characterized in that: the maximum height of the helical rib or the maximum depth of the helical groove is 1 to 4 mm, and the maximum radial height of the helical tube is 2 to 4 mm.
